(19) United States
(12) Patent Application Publication
(10) Pub. No.: US 2014/0165560 A1
(43) Pub. Date: Jun. 19, 2014

(54) LOW PRESSURE EGR AMMONIA OXIDATION CATALYST

(71) Applicant: CUMMINS IP, INC., Minneapolis, MN (US)

(72) Inventors: Cary A. Henry, Columbus, IN (US); Michael J. Ruth, Franklin, IN (US)

(73) Assignee: CUMMINS IP, INC., Minneapolis, MN (US)

(21) Appl. No.: 13/719,030

(22) Filed: Dec. 18, 2012

(51) Int. Cl. F02M 25/07; F02B 47/08

(52) U.S. Cl. CPC F02M 25/07; F02B 47/08
USPC 60/605.2

(57) ABSTRACT

An internal combustion engine system includes an internal combustion engine generating an exhaust gas stream and an air intake system coupled to the internal combustion engine. The engine system also includes a turbocharger that includes a turbine in exhaust gas receiving communication with the exhaust gas stream and a compressor in air receiving communication with the air intake line. Further, the engine system includes an exhaust system in exhaust gas receiving communication with the internal combustion engine. The exhaust system has a main exhaust line and a low pressure (LP) exhaust gas recirculation (EGR) line through which at least a portion of the exhaust gas in the main exhaust line downstream of the turbine is flowable into the air intake system. The exhaust system further includes an ammonia oxidation catalyst positioned within the LP EGR line.

### FIELD

This disclosure relates to internal combustion engines with a low pressure exhaust gas recirculation (EGR) line, and more particularly to controlling exhaust emissions with an exhaust aftertreatment system for such internal combustion engines.

### BACKGROUND

Emissions regulations for internal combustion engines have become more stringent over recent years. Environmental concerns have motivated the implementation of stricter emission requirements for internal combustion engines throughout much of the world. Governmental agencies, such as the Environmental Protection Agency (EPA) in the United States, carefully monitor the emission quality of engines and set acceptable emission standards, to which all engines must comply. Consequently, the use of exhaust aftertreatment systems on engines to reduce emissions is increasing.

Generally, emission requirements vary according to engine type. Emission tests for compression-ignited engines (e.g., diesel-powered engines) typically monitor the release of carbon monoxide, nitrogen oxides (NOx), and unburned hydrocarbons (UHC). Catalytic converters (e.g., oxidation catalysts) have been implemented in exhaust gas aftertreatment systems to oxidize at least some particulate matter in the exhaust stream and to reduce the unburned hydrocarbons and CO in the exhaust to less environmentally harmful compounds. To remove the particulate matter, a particulate matter (PM) filter is typically installed downstream from the oxidation catalyst or in conjunction with the oxidation catalyst. With regard to reducing NOx emissions, NOx reduction catalysts, including selective catalytic reduction (SCR) systems, are utilized to convert NOx (NO and NO₂ in some fraction) to N₂ and other compounds.

SCR systems utilize ammonia to reduce the NOx. When just the proper amount of ammonia is available at the SCR catalyst under the proper conditions, the ammonia is utilized to reduce NOx. However, if the reduction reaction rate is too slow, or if there is excess ammonia in the exhaust, ammonia can slip out the exhaust pipe. Ammonia is an undesirable emission. Accordingly, slips of even a few tens of ppm may be undesired. Additionally, due to the undesirability of handling pure ammonia, many systems utilize an alternate compound such as urea, which vaporizes and decomposes to ammonia in the exhaust stream. Presently available SCR systems use injected urea solutions as an indirect source of ammonia, and may not adequately account for the vaporization and hydrolysis of urea to component compounds such as ammonia and isocyanic acid. Some exhaust aftertreatment systems may employ an ammonia oxidation (AMOX) catalyst in the main exhaust line downstream of the SCR catalyst to convert at least some ammonia slipping from the SCR catalyst to N₂ and other less harmful compounds.

Certain conventional internal combustion engine systems utilize exhaust gas recirculation (EGR) techniques to reduce the amount of nitrous oxides in exhaust gas generated by an internal combustion engine. Generally, EGR techniques include recirculating a portion of the exhaust gas generated by a combustion event within a combustion chamber of the engine back into the combustion chamber for a future combustion event. The recirculated exhaust gas reduces the peak temperature of the combustion components during the combustion process. The lower temperature of the combustion components reduces the amount of nitrous oxides (NOx) generated as a result of the combustion process. Some EGR techniques may use a low pressure EGR line downstream of the turbine of a turbocharger.

To reduce the presence of particulate matter and debris in the low pressure EGR line, which may damage the compressor of the turbocharger, some exhaust aftertreatment systems include a PM filter in the low pressure EGR line.

### SUMMARY

The subject matter of the present application has been developed in response to the present state of the art, and in particular, in response to the problems and needs in the art that have not yet been fully solved by currently available exhaust aftertreatment systems used with engine systems having a low pressure (LP) exhaust gas recirculation (EGR) line. One problem associated with prior art exhaust aftertreatment systems used in conjunction with LP EGR lines is that ammonia present in the exhaust gas stream may pass into the LP EGR line, which may cause corrosion and pitting of the compressor wheel and other metallic components coupled to the LP EGR line. Further, other engine systems with LP EGR lines do not position a selective catalytic reduction (SCR) catalyst (e.g., a PM filter coated with a NOx-reducing catalytic coating) close to the engine exhaust outlet in a close-coupled manner.

Accordingly, the subject matter of the present application has been developed to provide an exhaust aftertreatment system for an internal combustion engine with an LP EGR line that overcomes at least some shortcomings of the prior art systems. For example, in one embodiment, the exhaust aftertreatment system includes a PM filter with a catalyst coating for converting ammonia in the LP EGR line into less harmful emissions. Accordingly, the exposure of a compressor wheel of a turbocharger to corrosive ammonia is reduced. As another example, in one embodiment, the exhaust aftertreatment system includes an SCR catalyst that is closely coupled to the engine outlet exhaust. Closely coupling the SCR catalyst to the engine outlet exhaust is facilitated by the presence of an ammonia oxidation catalyst downstream of the SCR catalyst within the LP EGR line.

According to one embodiment, an internal combustion engine system includes an internal combustion engine generating an exhaust gas stream and an air intake system coupled to the internal combustion engine. The engine system also includes a turbocharger that includes a turbine in exhaust gas receiving communication with the exhaust gas stream and a compressor in air receiving communication with the air intake line. Further, the engine system includes an exhaust system in exhaust gas receiving communication with the internal combustion engine. The exhaust system has a main exhaust line and a low pressure (LP) exhaust gas recirculation (EGR) line through which at least a portion of the exhaust gas in the main exhaust line downstream of the turbine is flowable into the air intake system. The exhaust system further includes an ammonia oxidation catalyst positioned within the LP EGR line.

In some implementations of the engine system, the exhaust system includes a particulate matter filter and an ammonia oxidation catalyst positioned within the LP EGR line. The ammonia oxidation catalyst and particulate matter filter can be integrated into a single component. The single component can be a particulate matter filter coated with a catalytic material. The exhaust system may include a particulate matter filter positioned within the main exhaust line upstream of the LP EGR line. Also, the exhaust system can include a particulate matter filter positioned within the main exhaust line downstream of the LP EGR line.

According to some implementations of the engine system, the exhaust system includes a selective catalytic reduction (SCR) catalyst positioned within the main exhaust line upstream of the LP EGR line, and a reductant delivery system configured to deliver reductant into the main exhaust line upstream of the SCR catalyst. The SCR catalyst can be a particulate matter filter coated with a NOx-reducing washcoat. Moreover, the SCR catalyst can be a first SCR catalyst, and the exhaust system can further include a second SCR catalyst positioned within the main exhaust line downstream of the LP EGR line.

In certain implementations of the engine system, the exhaust system includes an ammonia oxidation catalyst that is positioned within the main exhaust line upstream of the LP EGR line. The exhaust system may include an ammonia oxidation catalyst positioned within the main exhaust line downstream of the LP EGR line. According to some implementations, the exhaust system includes an SCR catalyst positioned within the main exhaust line downstream of the LP EGR line, and a reductant delivery system configured to deliver reductant into the main exhaust line upstream of the SCR catalyst. The exhaust system may include an oxidation catalyst positioned within the main exhaust line upstream of the LP EGR line.

According to another embodiment, an internal combustion engine system includes an internal combustion engine that generates an exhaust gas stream. The engine system also includes an air intake system that is in air providing communication with the internal combustion engine. Additionally, the engine system includes a turbocharger with a turbine in exhaust gas receiving communication with the exhaust gas stream and a compressor in air receiving communication with the air intake line. The engine system further includes an exhaust system in exhaust gas receiving communication with the internal combustion engine. The exhaust system includes a main exhaust line and an LP EGR line through which at least a portion of the exhaust gas in the main exhaust line downstream of the turbine is flowable into the air intake system. The exhaust system further includes a first oxidation catalyst positioned within the main exhaust line upstream of the LP EGR line and a second oxidation catalyst positioned within the LP EGR line.

In some implementations of this second embodiment of an engine system, the first oxidation catalyst includes first catalytic materials for oxidizing at least one of unburned hydrocarbons, carbon monoxide, and nitric oxide, and the second oxidation catalyst includes second catalytic materials for oxidizing ammonia. The exhaust system may include an SCR catalyst positioned within the main exhaust line upstream of the LP EGR line, and a reductant delivery system configured to deliver reductant into the main exhaust line upstream of the SCR catalyst. The second oxidation catalyst can be a particulate matter filter coated with an ammonia-oxidizing washcoat.

According to yet another embodiment, an exhaust system is disclosed for use with an internal combustion engine that has a turbocharger with a turbine in exhaust gas receiving communication with the engine and a compressor in air receiving communication with an air intake system. The exhaust system includes a main exhaust gas line in exhaust gas receiving communication with the turbine and an LP EGR line coupled to the main exhaust gas line at a location downstream of the turbine. The exhaust system further includes an ammonia oxidation catalyst positioned within the LP EGR line.

In some implementations of the exhaust system, the ammonia oxidation catalyst is a particulate matter filter that is coated with an ammonia-oxidizing washcoat. The exhaust system also may include a reductant delivery system that is configured to deliver reductant into the main exhaust line upstream of the LP EGR line. Further, the exhaust system can include an SCR catalyst positioned within the main exhaust line downstream of the reductant delivery system and one of upstream of the LP EGR line and downstream of the LP EGR line.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a schematic diagram of an internal combustion engine system having an exhaust system with an ammonia oxidation catalyst positioned within a low pressure (LP) exhaust gas recirculation (EGR) line according to one embodiment;

FIG. 2 is a schematic diagram of an internal combustion engine system having an exhaust system with a particulate matter filter coated with an ammonia oxidation washcoat positioned within an LP EGR line according to one embodiment;

FIG. 3 is a schematic diagram of an internal combustion engine system having an exhaust system with a particulate matter filter coated with an ammonia oxidation washcoat positioned within an LP EGR line, and an ammonia oxidation catalyst positioned within a main exhaust line of the engine system, according to one embodiment; and

FIG. 4 is a schematic diagram of an internal combustion engine system having an exhaust system with a particulate matter filter coated with an ammonia oxidation washcoat positioned within an LP EGR line, and a selective catalytic reduction (SCR) catalyst positioned within the main exhaust line, according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

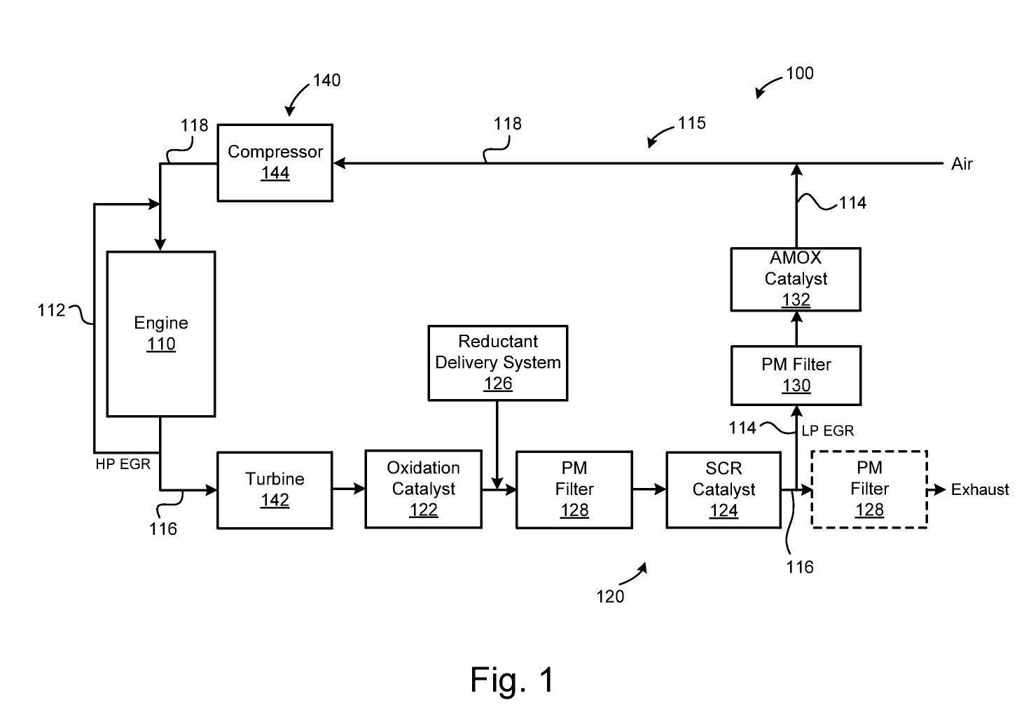

According to one specific embodiment of an internal combustion engine system 100 shown in FIG. 1, the system includes an internal combustion engine 110 coupled to an air intake system 115 and an exhaust system 120. The engine 110 can be a compression-ignited internal combustion engine, such as a diesel fueled engine, or a spark-ignited internal combustion engine, such as a gasoline fueled engine.

The air intake system 115 includes an air intake line 118 that directs air through the air intake system and into the internal combustion engine 110. The air intake line 118 may include a series of pipes or tubing through which the directed air flows. Positioned within the air intake line 118 is a compressor 144 of a turbocharger 140. Generally, the air intake system 115 includes an air inlet that is at essentially atmospheric pressure, thus enabling fresh air to enter the air intake system. The air in the intake system 115 is compressed by the compressor 144 to increase the pressure and density of the air before being introduced into the engine 110. The compressor 144 is co-rotatably driven by a turbine 142 of the turbocharger 140, which in turn is driven by the exhaust gas flow from the engine 110 as is known in the art. Although not shown, the air intake system 115 may include an air cooler that cools the air prior to being introduced into the engine 110.

Fuel is added to the air before being combusted in the engine 110. Fuel can be added to the air prior to the air entering the compressor 144, after the air exits the compressor but before entering the engine 110, or directly into the combustion chambers of the engine via one or more fuel injectors after the air enters the engine. Generally, the fuel is supplied from a fuel tank and pumped through a fuel delivery system via a fuel pump prior to being injected into the system. Whether the fuel is injected directly into the combustion chambers or injected into the air upstream of the engine, the combined fuel and air/EGR mixture is ignited and combusted via a compression-ignition system in some applications, and a spark-ignition system in other applications, to generate the pressure differential within the chambers for powering the engine. Combustion of the fuel produces exhaust gas that is operatively vented to the exhaust system 120.

Generally, the exhaust system 120 is configured to receive exhaust gas generated by the internal combustion engine 110, treat the exhaust gas to remove various chemical compounds and particulate emissions present in the exhaust gas, and then vent the treated exhaust gas to the atmosphere. The exhaust system 120 includes a main exhaust line 116 that directs exhaust gas from the engine 110 to the atmosphere. The main exhaust line 116 may include a series of pipes or tubing through which the directed exhaust gas flows. As illustrated, the exhaust system 120 includes the turbine 142 of the turbocharger 140, which is positioned within the main exhaust line 116. As mentioned above, energy from the heated and pressurized exhaust drives (e.g., rotates) the turbine 142, and thus the compressor 144. Accordingly, the energy and pressure of the exhaust gas exiting the turbine 142 is lower than the exhaust gas entering the turbine. For this reason, the exhaust gas stream flowing through the main exhaust line 116 from the engine 110 to the turbine 142 is considered high pressure (HP) exhaust flow, and the exhaust gas stream flowing through the main exhaust line from the turbine is considered low pressure (LP) exhaust flow.

The exhaust system 120 also includes a HP exhaust gas recirculation (EGR) line 112 and a LP EGR line 114. Both the HP and LP EGR lines 112, 114 are configured to operatively recirculate at least a portion of exhaust gas in the main exhaust line 116 back to the combustion chambers of the engine 110. As shown, the HP and LP EGR lines 112, 114 fluidly couple the main exhaust line 116 to the air intake line 118. In the illustrated embodiment, the HP EGR line 112 is coupled to the air intake line 118 downstream of the compressor 144 and the LP EGR line 114 is coupled to the air intake line upstream of the compressor. In other embodiments, the HP and LP EGR lines 112, 114 can be coupled to other locations on the air intake line 118, and in some instances, one or more of the HP and LP EGR lines can be directly coupled to the engine 110. Although not shown, each of the HP and LP EGR lines 112, 114 includes an associated valve that is actuatable to direct (e.g., vent) a controlled portion of the exhaust gas in the main exhaust line 116 back into the combustion chambers via the EGR lines. The EGR line 112 is considered a “high pressure” EGR line because it receives exhaust gas from the HP exhaust flow in the main exhaust line 116. Similarly, the EGR line 114 is considered a “low pressure” EGR line because it receives exhaust gas from the LP exhaust flow in the main exhaust line 116.

For exhaust gas to flow from the main exhaust line 116, through the LP EGR line 114, and into the air intake line 118, the pressure of the exhaust gas in the LP EGR line, and thus the main exhaust line 116 downstream of the turbine 142, must be higher than the pressure of the air in the air intake line. Accordingly, although not shown, the LP EGR line 114 may include a flow regulating device (e.g., an exhaust throttle) that ensures the necessary pressure differential is created between the main exhaust line 116 and air intake line 118. By closing the exhaust flow regulating device to allow less exhaust gas through, the device induces a backpressure in the main exhaust line 116, which effectively increases the pressure of the exhaust gas in the main exhaust line, thus creating the necessary pressure differential. Based on the pressure of the exhaust gas controlled by the flow regulating device, actuation of the LP EGR valve can be electronically controlled to provide a desired flow rate and concentration of recirculated exhaust gas into the air intake line 118. In some embodiments, the LP EGR exhaust gas may be mixed with air in the air intake line 118 by an air/EGR mixer (not shown). Also, although not shown, the HP and LP EGR lines 112, 114, each may include an EGR cooler to cool the EGR exhaust gas before being introduced into the air intake flow.

The exhaust system 120 also includes one or more exhaust treatment components for treating (i.e., removing pollutants from) the exhaust gas in order to meet regulated emissions requirements. Generally, emission requirements vary according to engine type. Emission tests for compression-ignition (diesel) engines typically monitor the release of carbon monoxide (CO), unburned hydrocarbons (UHC), diesel particulate matter (PM) such as ash and soot, and nitrogen oxides (NOx). Oxidation catalysts have been implemented in exhaust gas aftertreatment systems to oxidize at least some particulate matter in the exhaust stream and to reduce the unburned hydrocarbons and CO in the exhaust to less environmentally harmful compounds. To remove the particulate matter, a particulate matter (PM) filter is typically installed downstream from the oxidation catalyst or in conjunction with the oxidation catalyst. With regard to reducing NOx emissions, NOx reduction catalysts, including selective catalytic reduction (SCR) systems, are utilized to convert NOx (NO and NO₂ in some fraction) to N₂ and other compounds.

Referring to FIG. 1, the exhaust system 120 includes an oxidation catalyst 122 positioned within the main exhaust line 116 downstream of the turbine 142. The oxidation catalyst 122 can be any of various flow-through oxidation catalysts known in the art, such as diesel oxidation catalysts (DOC) used in diesel-powered applications. Generally, the oxidation catalyst 122 is configured to oxidize at least some particulate matter, e.g., the soluble organic fraction of soot, in the exhaust and reduce unburned hydrocarbons and CO in the exhaust to less environmentally harmful compounds. For example, the oxidation catalyst 122 may sufficiently reduce the hydrocarbon and CO concentrations in the exhaust to meet the requisite emissions standards. The oxidation catalyst 122 includes a catalyst bed exposed to the exhaust gas flowing through the main exhaust line 116 and past the bed. The catalyst bed includes a catalytic layer disposed on a washcoat or carrier layer. The washcoat can include any of various materials (e.g., oxides) capable of suspending the catalytic layer therein. The catalyst layer is made from one or more catalytic materials selected to react with (e.g., oxidize) one or more pollutants in the exhaust gas. The catalytic materials of the oxidation catalyst 122 can include any of various materials, such as precious metals (e.g., platinum, palladium, and rhodium), as well as other materials, such as transition metals cerium, iron, manganese, and nickel. Further, the catalyst materials can have any of various ratios relative to each other for oxidizing and reducing relative amounts and types of pollutants, such as unburned hydrocarbons and CO as desired.

The exhaust system 120 also includes a PM filter 128 positioned within the main exhaust line 116 downstream of the oxidation catalyst 122. The particulate filter 128 can be any of various particulate filters known in the art. Generally, the PM filter 128 is configured to reduce particulate matter concentrations (e.g., soot) in the exhaust gas to meet requisite emission standards. The PM filter 128 is designed to trap particulate matter constituents, which can be burnt-off through planned regeneration events. As shown in dashed lines in FIG. 1, the PM filter 128 optionally may be positioned within the main exhaust line 116 downstream of the LP EGR line 114 instead of upstream of the LP EGR line. In some embodiments, the exhaust system 120 may include a PM filter 128 upstream of the LP EGR line 114 (e.g., an inlet, takeoff, or drawpoint of the LP EGR line) and a PM filter 128 downstream of the LP EGR line.

Also shown in FIG. 1, the exhaust system 120 includes an additional PM filter 130 positioned within the LP EGR line 114. Accordingly, the PM filter 130 is configured to trap and filter particulate matter from the EGR gas flowing through the LP EGR line 114 before the EGR gas combines with intake air and passes through the compressor 144. In this manner, the exposure of the compressor 144 to harmful particulate matter is reduced.

For embodiments with a PM filter 128 upstream of the LP EGR line 114, at least some particulate matter is removed from the main exhaust before being redirected as EGR gas through the LP EGR line 114 and before flowing through the PM filter 130 in the LP EGR line. Accordingly, in some implementations, the PM filter 130 acts as a back-up PM filter in the event the PM filter 128 fails or is inefficient at removing particulate matter from exhaust in the main exhaust line 116. Further, even if the PM filter 128 in the main exhaust line 116 is performing satisfactorily, the PM filter 130 may be tuned to remove even finer particulate matter in the EGR gas. In other words, in certain implementations, the EGR gas exiting the PM filter 130 is cleaner (e.g., has less particulate matter per volume) than the exhaust gas exiting the PM filter 128. In this manner, the impact of particulate matter on the compressor 144 can be significantly reduced without the need to reduce the particulate matter in the main exhaust line 116 beyond regulated thresholds. Additionally, because the flow rate of exhaust gas through the LP EGR line 114 is less than the flow rate of exhaust gas through the main exhaust line 116 in most cases, the capacity and size of the PM filter 130 can be smaller than the PM filter 128. Moreover, the configuration, efficiency and/or type of the PM filter 128 can be different than the configuration, efficiency, and/or type of the PM filter 130.

Further, the exhaust system 120 includes an SCR catalyst 124 positioned within the main exhaust line 116 downstream of the PM filter 128. The exhaust system also includes a reductant delivery system 126 configured to deliver a reductant (e.g., aqueous urea or ammonia) to the exhaust gas in the main exhaust line 116 before the exhaust enters the SCR catalyst 124. When the reductant is urea, the urea decomposes to produce ammonia. When just the proper amount of ammonia is available at the SCR catalyst under the proper conditions, the ammonia is utilized to reduce NOx in the presence of the catalytic materials on the SCR catalyst. In some implementations, the catalytic material of the SCR catalyst 124 is a vanadium-based material, and in other implementations, the catalytic material a zeolite-based material.

If the NOx reduction reaction rate is too slow on the SCR catalyst 124, or if there is excess ammonia in the exhaust, ammonia can slip out of the SCR catalyst. As discussed above, ammonia is an undesirable emission and slips of even a few tens of ppm may be problematic. Moreover, as also mentioned above, ammonia is extremely corrosive. Therefore, ammonia slipping from the SCR catalyst 124 may cause damage to metallic components downstream of the SCR catalyst. Particularly the compressor.

To reduce the various negative effects of ammonia slippage, the exhaust system 120 includes an ammonia oxidation (AMOX) catalyst 132 positioned within the LP EGR line 114. In the illustrated embodiment, the AMOX catalyst 132 is positioned downstream of the PM filter 130. However, in other embodiments, the AMOX catalyst 132 can be positioned upstream of the PM filter 130, and even integrated with the PM filter 130 as will be explained in more detail below. The AMOX catalyst 132 can be any of various flow-through catalysts configured to react with (e.g., oxidize) ammonia to produce mainly nitrogen. Generally, the AMOX catalyst 132 is utilized to remove ammonia in the exhaust gas, such as ammonia that has slipped through or exited the SCR catalyst 124 without reacting with NOx in the exhaust.

The AMOX catalyst 132 includes a catalyst bed exposed to the exhaust gas flowing through the LP EGR line 114 and past the bed. The catalyst bed includes a washcoat or carrier layer. The washcoat layer can include any of various materials (e.g., oxides) capable of suspending catalytic materials therein. The washcoat layer is made from one or more catalytic materials selected to react with (e.g., oxidize) ammonia in the exhaust gas. The catalytic materials of the AMOX catalyst 132 can include any of various materials, such as precious metals platinum, palladium, and rhodium. In some implementations, to improve the selectivity of ammonia oxidation to N₂ and H₂O instead of NOx, the AMOX catalyst 132 may be a dual-layer catalyst with a washcoat made from a zeolite material and a platinum group metal (PGM). The zeolite material can be exchanged with a metal, such as copper and iron. In other implementations, the selectivity of the AMOX catalyst 132, the catalyst may be a dual-layer catalyst with a washcoat made from a vanadium-based material (e.g., V₂O₅) and a PGM. Further, the catalyst materials can have any of various ratios relative to each other for oxidizing and reducing certain levels of ammonia as desired.

Some EGR lines include an EGR cooler for lowering the temperature of EGR gas flowing through the EGR lines. Although an EGR cooler is not shown in the illustrated embodiments, one or both of the HP and LP EGR lines may include an EGR cooler. For example, in one embodiment, the LP EGR line 114 may include an EGR cooler downstream of the AMOX catalyst 132. Positioning the EGR cooler downstream of the AMOX catalyst 132 ensures the temperature of the exhaust gas passing through the AMOX catalyst 132 is relatively high to facilitate the ammonia conversion capabilities of the AMOX catalyst. In some embodiments, the EGR cooler can be positioned upstream of the AMOX catalyst 132. Although the cooler temperature of exhaust gas exiting the EGR cooler and passing through the AMOX catalyst 132 may decrease the conversion of ammonia in the AMOX catalyst, some AMOX catalysts can be configured to efficiently convert ammonia in lower exhaust temperatures.

Although the exhaust system 120 shown includes one of an oxidation catalyst 122, particulate filter 128, and SCR catalyst 124 in the main exhaust line 116, and a PM filter 130 and AMOX catalyst 132 in the LP EGR line 114, each positioned in specific locations relative to each other along the respective exhaust lines 114, 116, in other embodiments, the exhaust system 120 may include more than one of any of the various catalysts positioned in any of various positions relative to each other along the exhaust lines as desired. Further, although the oxidation catalyst 122 and AMOX catalyst 132 can be non-selective catalysts, in some embodiments, the oxidation and AMOX catalysts can be selective catalysts.

Additionally, in some implementations, the components of the exhaust system 120 may be housed in the same housings. In some embodiments, each oxidation catalyst, SCR catalyst, PM filter, and AMOX catalyst is housed within a respective, separate housing. However, in other embodiments, one or more of the oxidation catalyst, SCR catalyst, PM filters, and AMOX catalyst may be housed in the same housing. For example, where two or more components are housed within the same housing, the housing may house the catalyst beds or filter core adjacent each other within the housing. Accordingly, even though the components may be found within the same housing, the components are still physically separate from each other (e.g., not integrated with each other) within the housings.

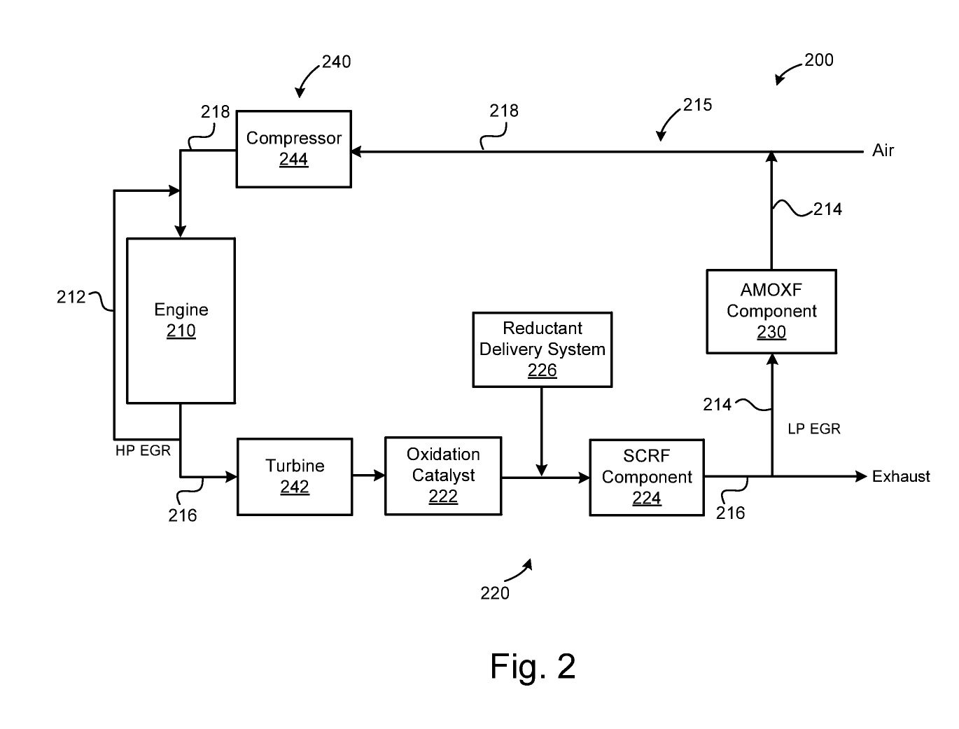

Alternatively, one or more of the components of the exhaust system 120 may be integrated with another one or more of the components to form a single component designed to perform the distinct functions of the integrated components. For example, as shown in FIG. 2, the SCR catalyst 124 and PM filter 128 may be integrated into a single SCRF component 224, and the PM filter 130 and AMOX catalyst 132 may be integrated into a single AMOXF component 230. FIG. 2 illustrates an embodiment of an internal combustion engine system 200 that includes features and components similar to the features and components of the engine system 100 of FIG. 1, with like numbers and titles referring to like elements. For example, the engine system 200 includes an engine 210, which in some implementations shares the same features as the engine 110 of engine system 100. Also, like the exhaust system 120, the exhaust system 220 of the engine system 200 includes a main exhaust line 216 in exhaust receiving communication with the engine 210, and an LP EGR line 214 in exhaust receiving communication with the main exhaust line and exhaust providing communication with an air intake line 218 of an air intake system 215. However, instead of a separate PM filter 128 and SCR catalyst 124 in the main exhaust line 216 upstream of the LP EGR line 214, the exhaust system 220 includes the SCRF component 224, and instead of a separate PM filter 130 and AMOX catalyst 132 in the LP EGR line 214, the exhaust system 220 includes the AMOXF component 230, as discussed above.

The SCRF component 224 includes a PM filter wall-flow substrate coated with a NOx reduction coating or washcoat. The PM filter wall-flow substrate can be any of various types of PM filter substrates known in the art. The NOx reduction coating can include any of various NOx-reducing catalytic materials, such as described above. Accordingly, the SCRF component 224 performs the dual functions of trapping particulate matter and reducing NOx or converting NOx to less harmful emissions.

The AMOXF component 230 includes a PM filter wall-flow substrate coated with an ammonia oxidation coating or washcoat. The PM filter wall-flow substrate can be any of various types of PM filter substrates known in the art. The ammonia oxidation coating can include any of various ammonia-oxidizing catalytic materials, such as described above. Accordingly, the AMOXF component 230 performs the dual functions of trapping particulate matter and oxidizing ammonia or converting ammonia into less harmful emissions, such as N₂ and H₂O. Accordingly, as defined herein, an AMOX catalyst is any component, whether a stand-alone AMOX catalyst, a PM filter with an ammonia oxidation coating, or other component, that oxidizes ammonia present in exhaust gas.

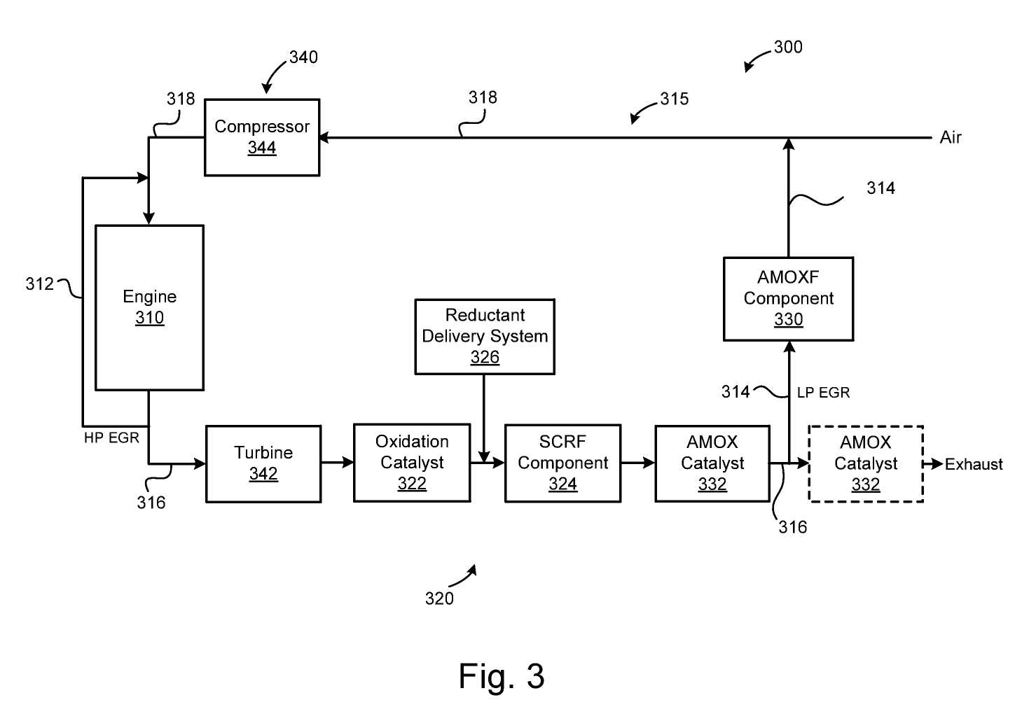

FIG. 3 illustrates an embodiment of an internal combustion engine system 300 that includes features and components similar to the features and components of the engine system 200 of FIG. 2, with like numbers and titles referring to like elements. For example, the engine system 300 includes an engine 310, which in some implementations shares the same features as the engine 210 of engine system 200. Also, like the exhaust system 220, the exhaust system 320 of the engine system 200 includes a main exhaust line 316 in exhaust receiving communication with the engine 310, and an LP EGR line 314 in exhaust receiving communication with the main exhaust line and exhaust providing communication with an air intake line 318 of an air intake system 315. The exhaust system 320 also includes an SCRF component 324 in the main exhaust line 316 upstream of the LP EGR line 314 and an AMOXF component 330 positioned in the LP EGR line. Although not shown, in some implementations, the SCRF component 324 may be replaced with a separate SCR catalyst and PM filter, and the AMOXF component 330 may be replaced with a separate PM filter and AMOX catalyst, as with the exhaust system 120 of FIG. 1.

The exhaust system 320 also includes an AMOX catalyst 332 positioned in the main exhaust line 316 upstream of the LP EGR line 314. Alternatively, as shown in dashed lines, the AMOX catalyst 332 can be positioned downstream of the LP EGR line 314 in some embodiments. The configuration of the AMOX catalyst 332 can be similar to that of the AMOX catalyst 132 as described above.

For embodiments with the AMOX catalyst 332 upstream of the LP EGR line 314, at least some ammonia is removed (e.g., oxidized) from the main exhaust gas before being redirected as EGR gas through the LP EGR line 314 and before flowing into the AMOXF component 330 in the LP EGR line 314. Accordingly, in some implementations, the AMOXF component 330 acts as a back-up AMOX catalyst in the event the AMOX catalyst 332 fails or is inefficient at oxidizing ammonia from exhaust in the main exhaust line 316. Further, even if the AMOX catalyst 332 in the main exhaust line 316 is performing satisfactorily, the AMOXF component 330 may be tuned to oxidize even more ammonia in the EGR gas. In other words, in certain implementations, the EGR gas exiting the AMOXF component 330 is cleaner (e.g., has less ammonia per volume) than the exhaust gas exiting the AMOX catalyst 332. In this manner, the impact of ammonia on the compressor 344 can be significantly reduced without the need to reduce the ammonia in the main exhaust line 316 beyond desired thresholds. Additionally, because the flow rate of exhaust gas through the LP EGR line 314 is less than the flow rate of exhaust gas through the main exhaust line 316 in most cases, the capacity and size of the ammonia oxidation portion of the AMOXF component 330 can be smaller than that of the AMOX catalyst 332. Moreover, the configuration, efficiency and/or type of the ammonia oxidation portion of the AMOXF component 330 can be different than the configuration, efficiency, and/or type of the AMOX catalyst 332.

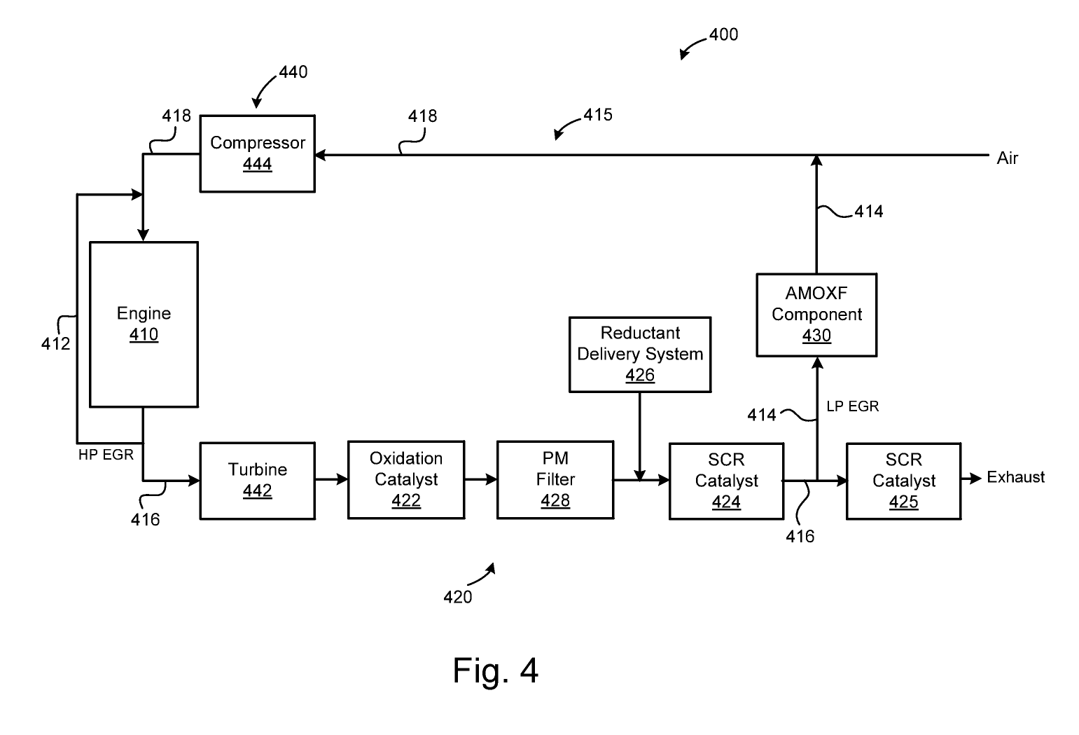

FIG. 4 illustrates another embodiment of an internal combustion engine system 400 that includes features and components similar to the features and components of the engine system 100 of FIG. 1, with like numbers and titles referring to like elements. For example, the engine system 400 includes an engine 410, which in some implementations shares the same features as the engine 110 of engine system 100. Also, like the exhaust system 120, the exhaust system 420 of the engine system 400 includes a main exhaust line 416 in exhaust receiving communication with the engine 410, and an LP EGR line 414 in exhaust receiving communication with the main exhaust line and exhaust providing communication with an air intake line 418 of an air intake system 415. The exhaust system 420 includes an AMOXF component 430 in the LP EGR line 414 similar to the AMOXF components 230, 330. The AMOXF component 430 may be replaced with a separate PM filter and AMOX catalyst, as with the exhaust system 120 of FIG. 1.

Like the exhaust system 120, the exhaust system 420 also includes an SCR catalyst 424 positioned in the main exhaust line 416 upstream of the LP EGR line 414. However, in contrast to the exhaust system 120, the exhaust system 120 includes a second SCR catalyst 425 positioned in the main exhaust line 416 downstream of the LP EGR line 414. The second or downstream SCR catalyst 425 may be configured to reduce NOx in the presence of the ammonia that has slipped from the first or upstream SCR catalyst 424. Accordingly, in some implementations, the exhaust system 420 may be configured to allow a certain amount of ammonia to slip from the upstream SCR catalyst 424 for the purposes of reducing NOx on the downstream SCR catalyst 425. Because the exhaust system 420 may purposely allow ammonia to slip from the upstream SCR catalyst 424, the AMOXF component 430 is necessary in the LP EGR line 414 to oxidize excess or slipped ammonia in the EGR line before it passes through the compressor 444.

Although not shown, in some implementations, either one or both of the upstream and downstream SCR catalysts 424, 425 may be replaced with an SCRF component, which would eliminate the need for a separate, stand-alone PM filter 428 upstream and/or downstream of the LP EGR line 414.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

The subject matter of the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An internal combustion engine system, comprising:
an internal combustion engine generating an exhaust gas stream;
an air intake system coupled to the internal combustion engine;
a turbocharger comprising a turbine in exhaust gas receiving communication with the exhaust gas stream and a compressor in air receiving communication with the air intake line;
an exhaust system in exhaust gas receiving communication with the internal combustion engine, the exhaust system comprising a main exhaust line and a low pressure (LP) exhaust gas recirculation (EGR) line through which at least a portion of the exhaust gas in the main exhaust line downstream of the turbine is flowable into the air intake system, the exhaust system further comprising an ammonia oxidation catalyst positioned within the LP EGR line.

2. The internal combustion engine system of claim 1, wherein the exhaust system comprises a particulate matter filter and an ammonia oxidation catalyst positioned within the LP EGR line.

3. The internal combustion engine system of claim 2, wherein the ammonia oxidation catalyst and particulate matter filter are integrated into a single component, the component comprising a particulate matter filter coated with a catalytic material.

4. The internal combustion engine system of claim 2, wherein the exhaust system comprises a particulate matter filter positioned within the main exhaust line upstream of the LP EGR line.

5. The internal combustion engine system of claim 2, wherein the exhaust system comprises a particulate matter filter positioned within the main exhaust line downstream of the LP EGR line

6. The internal combustion engine system of claim 1, wherein the exhaust system comprises a selective catalytic reduction (SCR) catalyst positioned within the main exhaust line upstream of the LP EGR line, and a reductant delivery system configured to deliver reductant into the main exhaust line upstream of the SCR catalyst.

7. The internal combustion engine system of claim 6, wherein the SCR catalyst comprises a particulate matter filter coated with a NOx-reducing washcoat.

8. The internal combustion engine system of claim 6, wherein the SCR catalyst is a first SCR catalyst, the exhaust system further comprising a second SCR catalyst positioned within the main exhaust line downstream of the LP EGR line.

9. The internal combustion engine system of claim 1, wherein the exhaust system comprises an ammonia oxidation catalyst positioned within the main exhaust line upstream of the LP EGR line.

10. The internal combustion engine system of claim 1, wherein the exhaust system comprises an ammonia oxidation catalyst positioned within the main exhaust line downstream of the LP EGR line.

11. The internal combustion engine system of claim 1, wherein the exhaust system comprises a selective catalytic reduction (SCR) catalyst positioned within the main exhaust line downstream of the LP EGR line, and a reductant delivery system configured to deliver reductant into the main exhaust line upstream of the SCR catalyst.

12. The internal combustion engine system of claim 1, wherein the exhaust system comprises an oxidation catalyst positioned within the main exhaust line upstream of the LP EGR line.

13. An internal combustion engine system, comprising:
an internal combustion engine generating an exhaust gas stream;
an air intake system in air providing communication with the internal combustion engine;
a turbocharger comprising a turbine in exhaust gas receiving communication with the exhaust gas stream and a compressor in air receiving communication with the air intake line;
an exhaust system in exhaust gas receiving communication with the internal combustion engine, the exhaust system comprising a main exhaust line and a low pressure (LP) exhaust gas recirculation (EGR) line through which at least a portion of the exhaust gas in the main exhaust line downstream of the turbine is flowable into the air intake system, the exhaust system further comprising a first oxidation catalyst positioned within the main exhaust line upstream of the LP EGR line and a second oxidation catalyst positioned within the LP EGR line.

14. The internal combustion engine system of claim 13, wherein the first oxidation catalyst comprises first catalytic materials for oxidizing at least one of unburned hydrocarbons, carbon monoxide, and nitric oxide, and the second oxidation catalyst comprises second catalytic materials for oxidizing ammonia.

15. The internal combustion engine system of claim 13, wherein the exhaust system comprises a selective catalytic reduction (SCR) catalyst positioned within the main exhaust line upstream of the LP EGR line, and a reductant delivery system configured to deliver reductant into the main exhaust line upstream of the SCR catalyst.

16. The internal combustion engine system of claim 13, wherein the second oxidation catalyst comprises a particulate matter filter coated with an ammonia-oxidizing washcoat.

17. An exhaust system for use with an internal combustion engine comprising a turbocharger having a turbine in exhaust gas receiving communication with the engine and a compressor in air receiving communication with an air intake system, the exhaust system comprising:
a main exhaust gas line in exhaust gas receiving communication with the turbine;
a low pressure (LP) exhaust gas recirculation (EGR) line coupled to the main exhaust gas line at a location downstream of the turbine; and
an ammonia oxidation catalyst positioned within the LP EGR line.

18. The exhaust system of claim 17, wherein the ammonia oxidation catalyst comprises a particulate matter filter coated with an ammonia-oxidizing washcoat.

19. The exhaust system of claim 17, further comprising a reductant delivery system configured to deliver reductant into the main exhaust line upstream of the LP EGR line.

20. The exhaust system of claim 19, further comprising a selective catalytic reduction (SCR) catalyst positioned within the main exhaust line downstream of the reductant delivery system and one of upstream of the LP EGR line and downstream of the LP EGR line.
